(19) United States
(12) Patent Application Publication
(10) Pub. No.: US 2026/0261452 A1
(43) Pub. Date: Sep. 3, 2026

(54) SENDING CAN SIGNALS OVER ULTRA-WIDEBAND WIRELESS COMPONENTS

(71) Applicant: DANFOSS POWER SOLUTIONS INC., Ames, IA (US)

(72) Inventors: Kyle Sweet, Maple Grove, MN (US); Jiadong Chen, Minneapolis, MN (US)

(21) Appl. No.: 19/474,219

(22) PCT Filed: Apr. 11, 2024
(86) PCT No.: PCT/US2024/023990

§ 371 Date: Oct. 10, 2025

Related U.S. Application Data
(60) Provisional application No. 63/458,475, filed on Apr. 11, 2023.

(51) Int. Cl. H04L 12/40; H01Q 1/50

(52) U.S. Cl. CPC H04L 12/40169; H01Q 1/50; H04L 2012/40215; H04L 2012/40273

(57) ABSTRACT

A system for transmitting control area network signals includes a first mechanical system, and a first component for determining conditions of the first mechanical system. The first component is provided with at least an ultra-wideband transmitter. A second component has at least an ultra-wideband receiver. The first component is operable to transmit at least one of a control signal and a diagnostic signal from the first mechanical system to the second component as a controller area network signal. A method is also disclosed.

WO

### RELATED APPLICATION(S)

This application claims the benefit of U.S. Provisional Application No. 63/458,475 , filed Apr. 11, 2023, the entirety of which is incorporated by reference.

### BACKGROUND

This application relates to a way of transmitting CAN signals, a known acronym for controller area network, over ultra-wideband radio technology.

CAN signals are utilized to communicate control signals and/or diagnostic signals between a system and a controller. Historically CAN signals have been transmitted on a hard wired bus.

As known, CAN stands for “controller area network” and is a vehicle bus standard design to allow microcontrollers and devices to communicate with each other. It is a message-based protocol designed originally for multiplex electrical wiring. It can also be used in many other contexts. Examples of applications using CAN signals are any type of vehicle, including combustion engine vehicles, electric vehicles, agricultural equipment, electronic equipment, for example used in aviation or navigation, industrial automation and mechanical controls, escalators, elevators, building automation, medical instruments and equipment, ships, railroads, 3D printers, robotics, automation and lighting control systems also all utilizing CAN signals.

Historically, CAN signals were sent over wire.

More recently various wireless protocols have been developed which are utilized to transmit CAN signals between a system and a control.

Many CAN wireless products are known. However, sending CAN signals over a wireless connection does raise challenges.

### SUMMARY

In a featured embodiment, a system for transmitting control area network signals includes a first mechanical system, and a first component for determining conditions of 1 the first mechanical system. The first component is provided with at least an ultra-wideband transmitter. A second component has at least an ultra-wideband receiver. The first component is operable to transmit at least one of a control signal and a diagnostic signal from the first mechanical system to the second component as a controller area network signal.

In another embodiment according to the previous embodiment, the ultra-wideband transmitter transmits on a bandwidth greater than or equal to 450 MHz.

In another embodiment according to any of the previous embodiments, the ultra-wideband transmitter transmits on a bandwidth greater than or equal to 500 MHz.

In another embodiment according to any of the previous embodiments, the second component is a control for a second mechanical component and the controller area network signal being sent is a control signal from the first mechanical system to the second mechanical component.

In another embodiment according to any of the previous embodiments, control is a joystick, and the second mechanical component is a moving section on a vehicle.

In another embodiment according to any of the previous embodiments, the first mechanical system is associated with a sensor which senses condition of the first mechanical system and the sensor transmitting a signal from the first component to the second component as a diagnostic signal to be evaluated by the second component.

In another embodiment according to any of the previous embodiments, the first mechanical system and the second component are included on a vehicle.

In another embodiment according to any of the previous embodiments, the first mechanical system is an engine on the vehicle, and the second component is a controller for the vehicle.

In another embodiment according to any of the previous embodiments, the first mechanical system is an engine and the second component is a control.

In another embodiment according to any of the previous embodiments, the second component is a control for a second mechanical component and the controller area network signal being sent is a control signal from the first mechanical system to the second mechanical component.

In another embodiment according to any of the previous embodiments, the control is a joystick, and the second mechanical component is a moving section on a vehicle. 2 In another embodiment according to any of the previous embodiments, the first mechanical system is associated with a sensor which senses condition of the first mechanical system and the sensor transmitting a signal from the first component to the second component as a diagnostic signal to be evaluated by the second component.

In another embodiment according to any of the previous embodiments, the first mechanical system and the second component are included on a vehicle.

In another embodiment according to any of the previous embodiments, the first mechanical system is an engine on the vehicle, and the second component is a controller for the vehicle.

In another embodiment according to any of the previous embodiments, the first mechanical system is an engine on the vehicle, and the second component is a controller for the vehicle.

In another featured embodiment, a method of operating a system includes the steps of utilizing a first mechanical system, with a first component determining conditions of the first mechanical system, and transmitting CAN signals in an ultra-wideband frequency to a second component, receiving the transmitted ultra-wideband signals, and the ultra-wideband signals being utilized by the second component.

In another embodiment according to any of the previous embodiments, the second component is a control for a second mechanical component and the ultra-wideband signal is a control signal from the first mechanical system to the second mechanical component, with the second component utilizing the signal to control the second mechanical component.

In another embodiment according to any of the previous embodiments, the control is a joystick, and the second mechanical component is a moving section on a vehicle.

In another embodiment according to any of the previous embodiments, further includes the steps of sensing conditions of the first mechanical system, and the ultra-wideband signal transmits the sensed conditions to the second component as a diagnostic signal.

In another embodiment according to any of the previous embodiments, the first mechanical system and the second component are included on a vehicle.

These and other features of the present invention can be best understood from the following specification and drawings, the following of which is a brief description. 3

### BRIEF DESCRIPTION OF THE DRAWINGS

FIG. 1A shows an application of an ultra-wideband connection between a system and a control.

FIG. 1B shows the FIG. 1A system utilized in a construction vehicle.

FIG. 2 shows another application in a passenger vehicle.

FIG. 3 shows results of a wireless CAN transmission as existing in the prior art.

FIG. 4 shows results of another wireless CAN transmission as existing in the prior art.

FIG. 5 is a graph that is similar to FIGS. 3 and 4 but showing the results of transmitting CAN signals using ultra-wideband technology.

### DETAILED DESCRIPTION

Ultra-wideband is a radio technology that can use a very low energy level for short-range, high-bandwidth communications over a large portion of the radio spectrum. Ultra-wideband has traditional application in sensor data collection, precise locating and tracking.

Ultra-wideband is a technology for transmitting information across a wide bandwidth. For purposes of this application, the ultra-wideband is defined as transmitting on a bandwidth greater than or equal to 450 megahertz (>450 MHz). More narrowly, ultra-wideband is defined as transmitting over a bandwidth greater than or equal to 500 megahertz (>500 MHz). Ultra-wideband allows for transmission of a large amount of signal energy without interfering with conventional narrow band interior wave transmission in the same frequency band.

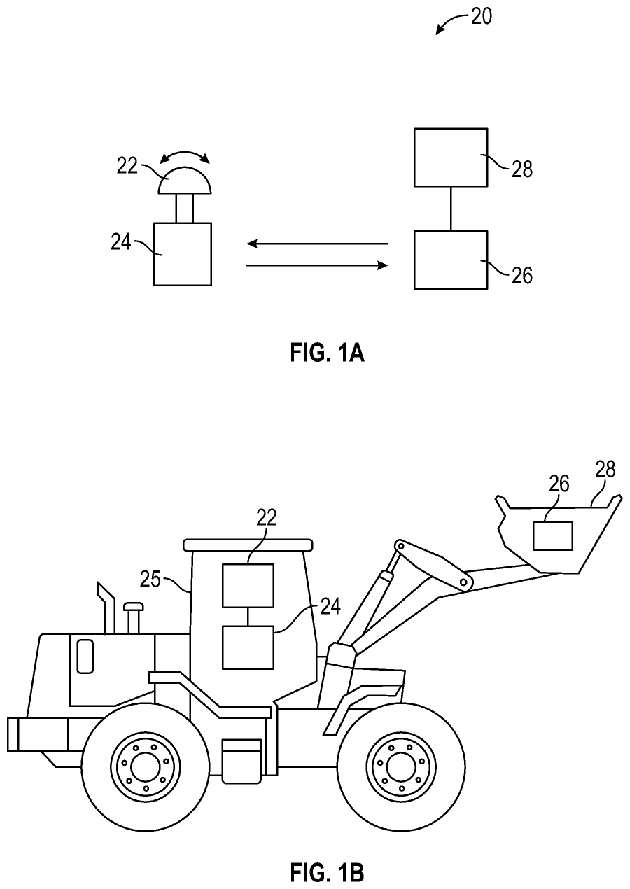

As shown in FIG. 1A, a system 20 includes a joystick 22 provided with a control 24 for controlling a tool 28. A control 26 is shown communicating with control 24 through a wireless connection that will utilize ultra-wideband technology. The control 26 may control a tool 28.

As an example shown in FIG. 1B, the joystick 22 and the control 24 may control a bucket 28 on a construction excavator 25 through control 26. However, any number of other applications may benefit from this disclosure.

4 The signals transmitted between controls 24 and 26 over ultra-wideband technology may include control signals as described above. Those signals may be controller area network (“CAN”) signals.

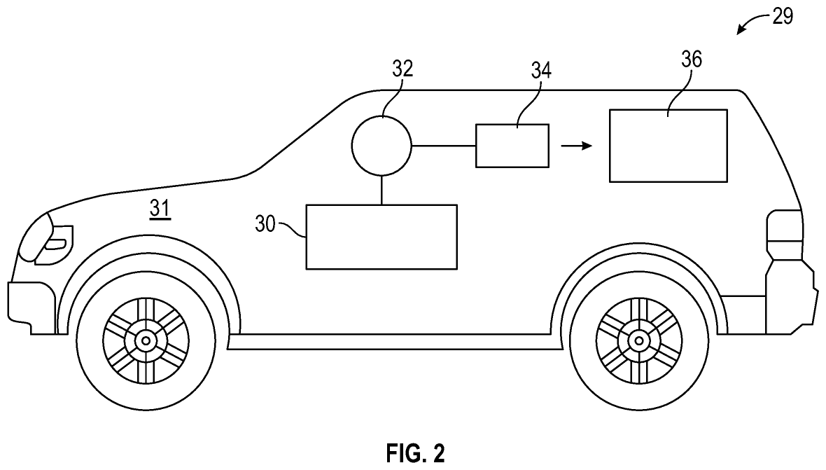

FIG. 2 shows another application 29 wherein a system, such as an engine 30, has a sensor 32 communicating with a control 34. The sensor 32 may develop diagnostic signals, as an example. Controller 34 communicates with a controller 36 through ultra-wideband technology. Again, the diagnostic signals which are transmitted are CAN signals transmitted through ultra-wideband technology.

A passenger vehicle 31 is shown using the system. Many other vehicle functions use CAN signals.

While CAN signals have been transmitted over wireless connections in the prior art, they have typically not been as quick as would be desired. As an example, when transmitting controller diagnostic signals it would be desirable to have them transmitted to the remote control as quickly as possible.

An effective wireless system must operate quickly. It is challenging for a CAN control system to tolerate delays. Some known wireless products can add undue delay.

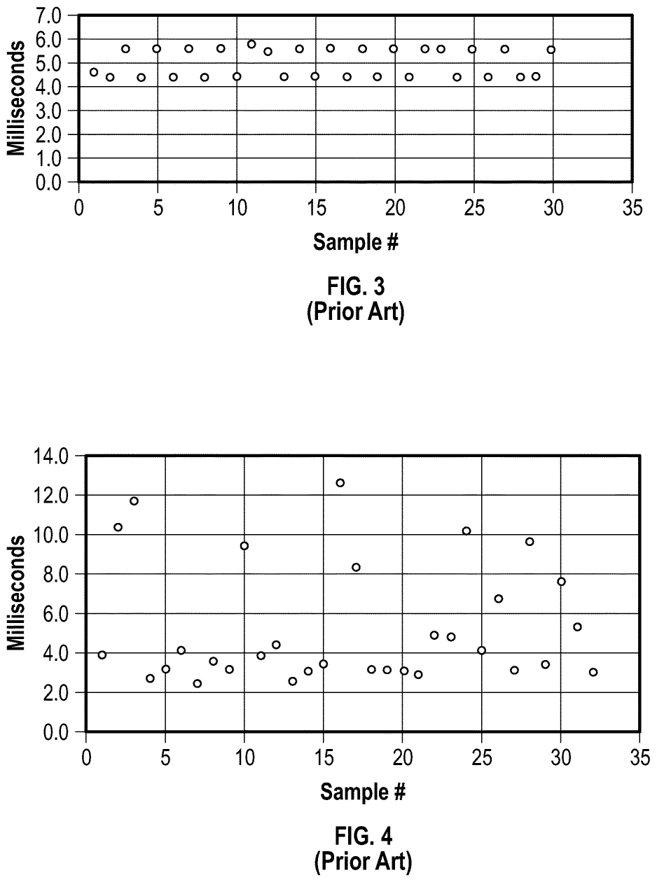

As can be seen in the FIG. 3 graph, a prior art system sends CAN message over one type of a wireless signal have been consistently taking 4.0-6.0 milliseconds. This system uses 2.4 GHz protocol.

FIG. 4 shows yet another type of wireless connection which can transmit CAN signals. However, there is a much greater variation in the time taken, including a significant portion greater than 10 milliseconds. Some of the signals are transmitted closer to 2.0 milliseconds but the variation will result in some signals taking too long. This system also uses 2.4 GHz, although distinct from FIG. 2.

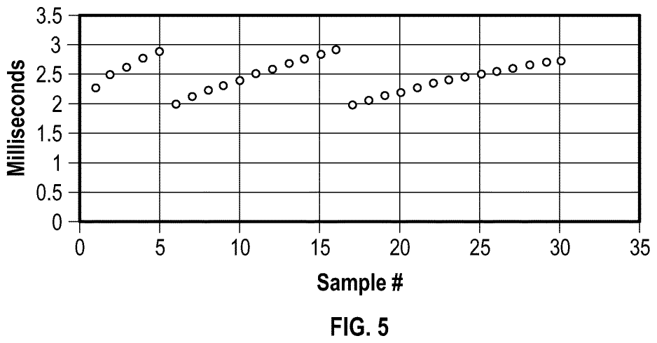

FIG. 5 shows CAN messages sent over an ultra-wideband technology. As can be seen, the signals are reliably between 2.0 and 3.0 milliseconds. Thus, ultra-wideband technology provides valuable benefits in reliability and speed for transmitting messages.

Although embodiments of this disclosure have been shown, a worker of ordinary skill in this art would recognize that modifications would come within the scope of this disclosure. For that reason, the following claims should be studied to determine the true scope and content of this disclosure.

What is claimed is:

1. A system for transmitting control area network signals:
A first mechanical system, and a first component for determining conditions of the first mechanical system, said first component being provided with at least an ultra-wideband transmitter;
a second component having at least an ultra-wideband receiver, and said first component being operable to transmit at least one of a control signal and a diagnostic signal from the first mechanical system to the second component as a controller area network signal.

2. The system as set forth in claim 1, wherein the ultra-wideband transmitter transmits on a bandwidth greater than or equal to 450 MHZ.

3. The system as set forth in claim 2, wherein the ultra-wideband transmitter transmits on a bandwidth greater than or equal to 500 MHz.

4. The system as set forth in claim 2, wherein the second component is a control for a second mechanical component and the controller area network signal being sent is a control signal from the first mechanical system to the second mechanical component.

5. The system as set forth in claim 4, wherein control is a joystick, and the second mechanical component is a moving section on a vehicle.

6. The system as set forth in claim 2, wherein the first mechanical system is associated with a sensor which senses condition of the first mechanical system and the sensor transmitting a signal from the first component to the second component as a diagnostic signal to be evaluated by the second component.

7. The system as set forth in claim 6, wherein the first mechanical system and the second component are included on a vehicle. 6

8. The system as set forth in claim 7, wherein the first mechanical system is an engine on the vehicle, and the second component is a controller for the vehicle.

9. The system as set forth in claim 6, wherein the first mechanical system is an engine and the second component is a control.

10. The system as set forth in claim 1, wherein the second component is a control for a second mechanical component and the controller area network signal being sent is a control signal from the first mechanical system to the second mechanical component.

11. The system as set forth in claim 10, wherein the control is a joystick, and the second mechanical component is a moving section on a vehicle.

12. The system as set forth in claim 1, wherein the first mechanical system is associated with a sensor which senses condition of the first mechanical system and the sensor transmitting a signal from the first component to the second component as a diagnostic signal to be evaluated by the second component.

13. The system as set forth in claim 12, wherein the first mechanical system and the second component are included on a vehicle.

14. The system as set forth in claim 13, wherein the first mechanical system is an engine on the vehicle, and the second component is a controller for the vehicle.

15. The system as set forth in claim 12, wherein the first mechanical system is an engine on the vehicle, and the second component is a controller for the vehicle. 7

16. A method of operating a system comprising the steps of:
utilizing a first mechanical system, with a first component determining conditions of the first mechanical system, and transmitting CAN signals in an ultra-wideband frequency to a second component, receiving the transmitted ultra-wideband signals, and the ultra-wideband signals being utilized by the second component.

17. The method as set forth in claim 16, wherein the second component is a control for a second mechanical component and the ultra-wideband signal is a control signal from the first mechanical system to the second mechanical component, with the second component utilizing the signal to control the second mechanical component.

18. The method as set forth in claim 17, wherein the control is a joystick, and the second mechanical component is a moving section on a vehicle.

19. The method as set forth in claim 16, further including the steps of sensing conditions of the first mechanical system, and the ultra-wideband signal transmits the sensed conditions to the second component as a diagnostic signal.

20. The method as set forth in claim 19, wherein the first mechanical system and the second component are included on a vehicle. 8
